(19) United States
(12) Patent Application Publication
(10) Pub. No.: US 2013/0043111 A1
(43) Pub. Date: Feb. 21, 2013

(54) CIRCUIT BREAKER POSITION SENSING AND HEALTH MONITORING SYSTEM

(71) Applicants: Kannan Venkitachalam, Bangalore (IN); Dinesh Naik, Bangalore (IN); Kumaran Sena Narasimhan, Bangalore (IN); Dathathreya Durgadhahalli Ganesh, Bangalore (IN); Madhan Raj Bagianathan, Bangalore (IN); Manikandan M, Bangalore (IN); Kantharaju T, Bangalore (IN)

(72) Inventors: Kannan Venkitachalam, Bangalore (IN); Dinesh Naik, Bangalore (IN); Kumaran Sena Narasimhan, Bangalore (IN); Dathathreya Durgadhahalli Ganesh, Bangalore (IN); Madhan Raj Bagianathan, Bangalore (IN); Manikandan M, Bangalore (IN); Kantharaju T, Bangalore (IN)

(73) Assignee: HONEYWELL INTERNATIONAL INC., Morristown, NJ (US)

(21) Appl. No.: 13/210,134

(22) Filed: Aug. 15, 2011

(51) Int. Cl. H01H 3/02

(52) U.S. Cl. 200/329

(57) ABSTRACT

A circuit breaker includes a breaker housing, a stationary contact, a movable contact, an operating shaft, and a linear position sensor. The stationary contact is non-movably mounted within the breaker housing, and the movable contact is movably mounted within the breaker housing. The movable contact is coupled to receive an input force and is configured, upon receipt of the input force, to move between a closed position, in which the movable contact is electrically coupled to the stationary contact, and an open position, in which the movable contact is electrically isolated from the stationary contact. The operating shaft is coupled to the movable contact to supply the input force thereto. The linear position sensor is connected to the operating shaft and is configured, upon movement of the operating shaft, to supply a position signal representative of movable contact position.

### TECHNICAL FIELD

The present invention generally relates to circuit breakers, and more particularly relates to a circuit breaker position sensing and health monitoring system.

### BACKGROUND

Many electrical power distribution circuits include circuit breakers. The primary function of a circuit breaker is to interrupt the flow of electrical current in the unlikely occurrence of a fault or other event that may result in undesirably high current flow. Circuit breakers also provide a means for temporarily de-energizing portions of a circuit to allow maintenance or repairs to be conducted on the circuit.

Many circuit breakers include position sensing devices to provide an indication of the position of the circuit breaker. Many high power circuit breakers are configured with rotary angular position sensors. These rotary angular position sensors are configured to sense rotational movement and position of a link lever mechanism that is coupled to the breaker via other link mechanisms. These sensors thus exhibit relatively long response times, less accuracy, and less reliability due to the location of the sensing area and number of link mechanisms involved. These drawbacks can additionally inhibit accurate health monitoring of the circuit breaker.

Hence, there is a need for a circuit breaker position sensing configuration to more accurately and reliably sense circuit breaker position and/or control circuit breaker function and/or improve health monitoring of circuit breakers. The present invention addresses one or more of these needs.

### BRIEF SUMMARY

In one embodiment, a circuit breaker system includes a breaker housing, a stationary contact, a movable contact, an operating shaft, and a linear position sensor. The stationary contact is non-movably mounted within the breaker housing, and the movable contact is movably mounted within the breaker housing. The movable contact is coupled to receive an input force and is configured, upon receipt of the input force, to move between a closed position, in which the movable contact is electrically coupled to the stationary contact, and an open position, in which the movable contact is electrically isolated from the stationary contact. The operating shaft is coupled to the movable contact to supply the input force thereto. The linear position sensor is connected to the operating shaft and is configured, upon movement of the operating shaft, to supply a position signal representative of movable contact position.

In another embodiment, a circuit breaker system includes a breaker housing, a stationary contact, a movable contact, an operating shaft, a linear magnetic position sensor, a position circuit, and a health monitoring circuit. The stationary contact is non-movably mounted within the breaker housing, and the movable contact is movably mounted within the breaker housing. The movable contact is coupled to receive an input force and is configured, upon receipt of the input force, to move between a closed position, in which the movable contact is electrically coupled to the stationary contact, and an open position, in which the movable contact is electrically isolated from the stationary contact. The operating shaft is coupled to the movable contact to supply the input force thereto. The linear magnetic position sensor is connected to the operating shaft and is configured, upon movement of the operating shaft, to supply a position signal representative of movable contact position. The position circuit is coupled to receive the position signal from the linear position sensor and is configured, upon receipt thereof, to determine at least when the movable contact is in the closed position and the open position and supply one or more breaker position signals representative of movable contact position. The health monitoring circuit is coupled to receive the position signal from the linear position sensor and is configured, upon receipt thereof, to determine circuit breaker health and generate data representative thereof.

Furthermore, other desirable features and characteristics of the circuit breaker position sensing system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1, which is the sole FIGURE, depicts a functional block diagram of one example of an embodiment of a circuit breaker system.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

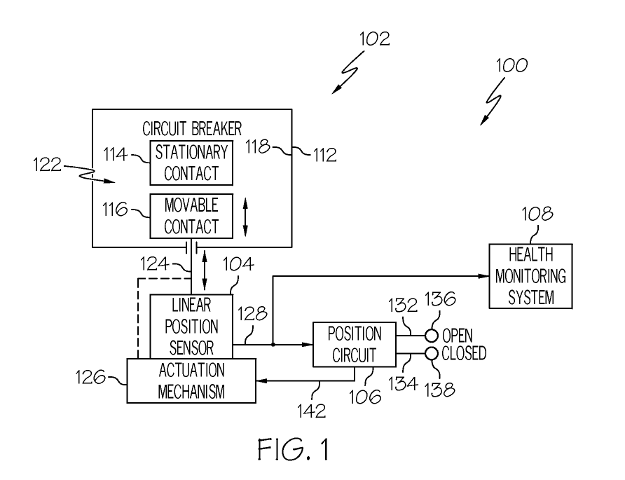

Referring now to FIG. 1, a functional block diagram of one exemplary embodiment of a circuit breaker system 100 is depicted, and includes a circuit breaker 102, a linear position sensor 104, a position circuit 106, and a health monitoring system 108. The circuit breaker 102, which may be implemented using any one of numerous types of circuit breakers, includes a breaker housing 112, a stationary contact 114, and a movable contact 116. The breaker housing 112 includes an inner surface 118 that defines an inner volume 122, within which the stationary and movable contacts 114, 116 are disposed.

The stationary contact 114 is non-movably mounted within the breaker housing 112, and the movable contact 116 is movably mounted within the breaker housing 112. The movable contact 116 is configured, upon receipt of an input force, to move between a closed position and an open position. In the closed position, the movable contact 116 is electrically coupled to the stationary contact 104. Conversely, when the movable contact 116 is in the open position, which is the position depicted in FIG. 1, the movable contact 116 is electrically isolated from the stationary contact 114.

The movable contact 106, as was noted above, is moved between the closed and open positions upon receipt of an input force. The input force is supplied to the movable contact 106 via an operating shaft 124 that is coupled to the movable contact 116. More specifically, at least in the depicted embodiment, the operating shaft 124 is also coupled to an actuation mechanism 126, which is configured to selectively supply the input force to the movable contact 116 via the operating shaft 124. The actuation mechanism 126 may be variously implemented, and may be coupled to the operating shaft 124 using any one of numerous techniques. In FIG. 1, the coupling of the actuation mechanism 126 to the operating shaft 124 is depicted using dotted lines. This is to indicate that the actuation mechanism 126 may be coupled to the operating shaft 124 either directly or via various numbers of intervening linkage mechanisms.

Typically, the circuit breaker 102 is configured such that the non-movable contact 116 is in the closed position. However, should an abnormality occur in the system in which the circuit breaker 102 is installed, resulting in an undesirably high current flow, the actuation mechanism 126 will be actuated and supply an input force to the operating rod 124 to cause the movable contact 116 to move to the open position. As a result, the movable contact 116 is electrically isolated from the stationary contact 114.

The linear position sensor 104 is connected to the operating shaft 124 and is configured, upon movement of the operating shaft 123, to supply a position signal 128 representative of the position of the movable contact 116. Unlike presently known circuit breaker position sensors, the linear position sensor 104 directly senses the position of the operating shaft 124, and thus the movable contact 116, rather than indirectly via rotation or translation of one or more linkage mechanisms or components that may be coupled between the actuation mechanism 126 and the operating shaft 124. It will be appreciated that the linear position sensor 104 may be implemented using any one of numerous types of suitable sensors. Preferably, however, it is implemented using a non-contact magnetic sensor, non-limiting examples of which include non-contact anisotropic magnetic resistance (AMR) sensors, giant magnetic resistance (GMR) sensors, tunneling magnetic resistance (TMR) sensors, and Hall-effect sensors.

No matter the particular type of sensor that is used to implement the linear position sensor 104, the position signal 128 is supplied to the position circuit 106 and to the health monitoring circuit 108. The position circuit 106 is coupled to receive the position signal 128 and is configured, upon receipt thereof, to determine at least when the movable contact 116 is in the closed position and the open position. That is, it could be configured to determine only when the movable contact 116 is in the closed and open positions, or it could be configured to continuously sense the position of the movable contact 116. In either case, the position circuit 106, at least in the depicted embodiment, is additionally configured to supply one or more breaker position signals representative of movable contact position. In the depicted embodiment, the position circuit 106 is configured to selectively supply an open signal 132 and a closed signal 134 to an open indicator 136 and a closed indicator 138, respectively. The open and closed indicators 136, 138, in response to the open and close signals 132, 134, supply indicia representative of movable contact position.

As FIG. 1 further depicts, and depending upon the configuration of the actuation mechanism 126, the position circuit 106 may additionally be configured to supply a position signal 142 to the actuation mechanism 126. The actuation mechanism 126 may additionally be configured, in response to the position signal 142, to selectively supply the input force to and remove the input force from the operating shaft 124 and thus the movable contact 116.

The health monitoring system 108 may be implemented using any one of numerous known devices, systems, and/or components for monitoring system/component health. In the depicted embodiment, the health monitoring circuit 108 is coupled to receive the position signal 128 from the linear position sensor 104 and is configured, upon receipt thereof, to determine circuit breaker health and generate data representative thereof. The health monitoring circuit 108 may be used to monitor, for example, the response times of the circuit breaker 102, and the total number of open-close cycles of the circuit breaker 102, just to name a few characteristics.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A circuit breaker system, comprising:
a breaker housing;
a stationary contact non-movably mounted within the breaker housing;
a movable contact movably mounted within the breaker housing, the movable contact coupled to receive an input force and configured, upon receipt of the input force, to move between a closed position, in which the movable contact is electrically coupled to the stationary contact, and an open position, in which the movable contact is electrically isolated from the stationary contact;
an operating shaft coupled to the movable contact to supply the input force thereto; and
a linear position sensor connected to the operating shaft and configured, upon movement of the operating shaft, to supply a position signal representative of movable contact position.

2. The circuit breaker system of claim 1, wherein the linear position sensor comprises a non-contact magnetic sensor.

3. The circuit breaker system of claim 2, wherein the non-contact magnetic sensor comprises a magnetic resistance (MR) sensor.

4. The circuit breaker system of claim 3, wherein the MR sensor is selected from the group consisting of an anisotropic magnetic resistance (AMR) sensor, a giant magnetic resistance (GMR) sensor, and a tunneling magnetic resistance (TMR) sensor.

5. The circuit breaker system of claim 2, wherein the non-contact magnetic sensor comprises a Hall-effect sensor.

6. The circuit breaker system of claim 1, further comprising:
a position circuit coupled to receive the position signal from the linear position sensor and configured, upon receipt thereof, to (i) determine at least when the movable contact is in the closed position and the open position and (ii) supply one or more breaker position signals representative of movable contact position.

7. The circuit breaker system of claim 6, further comprising:
an indicator coupled to receive the one or more breaker position signals and supply indicia representative of movable contact position.

8. The circuit breaker system of claim 6, further comprising:
an actuation mechanism coupled to the operating shaft and configured to selectively supply the input force to the movable contact via the operating shaft.

9. The circuit breaker system of claim 8, wherein the actuation mechanism is further coupled to receive the one or more breaker position signals and is further configured, in response thereto, to selectively supply the input force to and remove the input force from the movable contact.

10. The circuit breaker system of claim 1, further comprising:
a health monitoring circuit coupled to receive the position signal from the linear position sensor and configured, upon receipt thereof, to determine circuit breaker health and generate data representative thereof.

11. A circuit breaker system, comprising:
a breaker housing;
a stationary contact non-movably mounted within the breaker housing;
a movable contact movably mounted within the breaker housing, the movable contact coupled to receive an input force and configured, upon receipt of the input force, to move between a closed position, in which the movable contact is electrically coupled to the stationary contact, and an open position, in which the movable contact is electrically isolated from the stationary contact;
an operating shaft coupled to the movable contact to supply the input force thereto;
a linear magnetic position sensor connected to the operating shaft and configured, upon movement of the operating shaft, to supply a position signal representative of movable contact position;
a position circuit coupled to receive the position signal from the linear position sensor and configured, upon receipt thereof, to (i) determine at least when the movable contact is in the closed position and the open position and (ii) supply one or more breaker position signals representative of movable contact position; and
a health monitoring circuit coupled to receive the position signal from the linear position sensor and configured, upon receipt thereof, to determine circuit breaker health and generate data representative thereof.

12. The circuit breaker system of claim 11, wherein linear magnetic position sensor comprises a non-contact magnetic sensor.

13. The circuit breaker system of claim 12, wherein the non-contact magnetic sensor comprises a magnetic resistance (MR) sensor.

14. The circuit breaker system of claim 13, wherein the MR sensor is selected from the group consisting of an anisotropic magnetic resistance (AMR) sensor, a giant magnetic resistance (GMR) sensor, and a tunneling magnetic resistance (TMR) sensor.

15. The circuit breaker system of claim 12, wherein the non-contact magnetic sensor comprises a Hall-effect sensor.

16. The circuit breaker system of claim 11, further comprising:
an indicator coupled to receive the one or more breaker position signals and supply indicia representative of movable contact position.

17. The circuit breaker system of claim 11, further comprising:
an actuation mechanism coupled to the operating shaft and configured to selectively supply the input force to the movable contact via the operating shaft.

18. The circuit breaker system of claim 17, wherein the actuation mechanism is further coupled to receive the one or more breaker position signals and is further configured, in response thereto, to selectively supply the input force to and remove the input force from the movable contact.
